(19) United States
(12) Patent Application Publication
(10) Pub. No.: US 2026/0291785 A1
(43) Pub. Date: Sep. 24, 2026

(54) Distributed Unit and Method Performed Therein for Handling Communication in a Communication Network

(71) Applicant: Telefonaktiebolaget LM Ericsson (publ), Stockholm (SE)

(72) Inventors: Karl Werner, Segeltorp (SE); Jonas Karlsson, Upplands Väsby (SE); Christos Vranas, Stockholm (SE); Johan Axnäs, Solna (SE)

(21) Appl. No.: 19/478,502

(22) PCT Filed: Jun. 20, 2024
(86) PCT No.: PCT/EP2024/067311

§ 371 Date: Oct. 24, 2025

(30) Foreign Application Priority Data
Jun. 22, 2023 (GR) 20230100502

(51) Int. Cl. H04L 25/03; H04L 25/02

(52) U.S. Cl. CPC H04L 25/03993; H04L 25/0224

(57) ABSTRACT

Embodiments herein relate to a method performed by a DU (14) of a radio network node (12) for handling communication in a communications network. The DU (14) receives from a radio unit (13) of the radio network node (12), a port reduction mapped signal, and applies a whitening filter to the port reduction mapped signal to create another signal that is used in subsequent processing.

### TECHNICAL FIELD

Embodiments herein relate to a distributed unit (DU) of a radio network node and a method performed therein. Furthermore, a computer program product and a computer-readable storage medium are also provided herein. In particular, embodiments herein relate to handling communication in a communication network.

### BACKGROUND

In a typical communication network, user equipments (UE), also known as wireless communication devices, mobile stations, stations (STA) and/or wireless devices, communicate via a Radio Access Network (RAN) to one or more core networks (CN). The RAN covers a geographical area which is divided into service areas or cell areas, with each service area or cell area being served by a radio network node such as an access node e.g. a Wi-Fi access point or a radio base station (RBS), which in some radio access technologies (RAT) may also be called, for example, a NodeB, an evolved NodeB (eNodeB) and a gNodeB (gNB). The service area or cell area is a geographical area where radio coverage is provided by a radio network node. The radio network node operates on radio frequencies to communicate over an air interface with the UEs within range of the access node. The radio network node communicates over a downlink (DL) to the UE, and the UE communicates over an uplink (UL) to the access node.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipments. In a forum known as the Third Generation Partnership Project (3GPP), telecommunications suppliers propose and agree upon standards for present and future generation networks and UTRAN specifically, and investigate enhanced data rate and radio capacity. In some RANs, e.g., as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more CNs.

Specifications for the Evolved Packet System (EPS) have been completed within the 3^{rd} Generation Partnership Project (3GPP) and this work continues in the coming 3GPP releases, such as fifth generation (5G) and sixth generation (6G) networks. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the RAN of an EPS has an essentially non-hierarchical architecture comprising radio network nodes connected directly to one or more CNs.

With the emerging 5G technologies also known as new radio (NR), the use of very many transmit- and receive-antenna elements may utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

Apart from the network densification and new frequency bands, the exponential increase of the number of subscribers requires a more flexible network radio access network (RAN) architecture characterized by decomposition of the RAN functionalities. Open RAN (O-RAN) is a term referred by operators and vendors to open the RAN architecture in order to facilitate the network deployment by incorporating equipment from multiple vendors and preserving the concept of proprietary solutions from each vendor. Some components of the RAN architecture are the radio equipment controller (REC) and radio equipment (RE), which correspond to the baseband and the radio remote heads (RRH) respectively at the gNB. Note that in O-RAN, the REC is called O-RAN Distributed Unit (O-DU) and the RE is called O-RAN Radio Unit (O-RU). For sake of simplicity, the terms RU and DU will be used. Lower Layer Split (LLS) is the fronthaul interface between RU and DU. It is important to ensure lower complexity of the RU functionality in order to facilitate the network densification. By splitting the functionalities of RU and DU in a proper way, a good compromise of the requirements between the centralized component and the fronthaul could be achieved. The O-RAN specification has chosen a split that is close to the 7-2 functional split. For the uplink this means that Fast Fourier Transform (FFT)/cyclic prefix (CP) removal, beamforming and resource element de-mapping are located in the RU, and that channel estimation/equalization, inverse Discrete Fourier Transform (IDFT), de-modulation and decoding are located in the DU.

Reference signals occupy time-frequency resources and are used for different purposes by the receiver. In NR, there are multiple reference signals where each one has different functionality and could be used only when it's required, thus achieving ultra-lean transmissions. Demodulation reference signals (DMRS) are used for channel estimation for the purpose of demodulation at the receiver side. DMRS is used to demodulate physical uplink shared channel (PUSCH) at the gNB and physical downlink shared channel (PDSCH) at the UE side respectively and it is present only in physical resource blocks which include PUSCH (UL) or PDSCH (DL). Non-orthogonal DMRS sequences might create issues with the channel estimation which might be translated into capacity losses in a multi-user scenario, e.g., multiple input multiple output (MIMO) such as multi-user MIMO (MU-MIMO), where multiple UEs use the physical resources for the data transmission. On the other hand, there is a limitation in the number of the orthogonal sequences that could be generated by using orthogonal cover codes (OCC) to provide orthogonal DMRS ports. For instance, time OCC is related to the number of DMRS symbols and length-2 OCC is supported from the current specification. It should be noted that DMRS that are made orthogonal based on code division multiplexing (CDM) are only perfectly orthogonal if the channel is identical on adjacent DMRS resource elements, and with channel fading/time dispersion, so constructed DMRS are no longer be perfectly orthogonal. Consequently, the number of UEs that can have truly orthogonal DMRS in NR is strongly limited, e.g., max 2 UEs with DMRS Type I with single symbol configuration.

In O-RAN LLS a filtering method can be applied in order to achieve port reduction ending up with fewer effective spatial layers being transmitted over the LLS. Port reduction could alleviate the problem of the bandwidth limitation between RU and DU.

### SUMMARY

As part of developing embodiments herein one or more problems have been identified.

Due to limitations in interface bandwidth, the full received signal cannot be transferred across the LLS between RU and DU. Instead, the signal is often transferred in frequency domain, and it may also be using a port reduction, which is a linear mapping, that reduces the N receive antennas (or beams) down to L streams with L<N). The received signal at the DU, on resource element k, may be written as:

$${r}_{k} = {W}_{k} {H}_{k} {x}_{k} + {W}_{k} {n}_{k}$$

where the received signal, rₖ, and the transmitted signal, for all users/layers, xₖ, are Lx1 vectors, Hₖ is the effective radio channel (such as a N×L matrix), nₖ is the receiver noise/interference at RU, and Wₖ is the port reduction linear mapping (such as a L×N matrix). The effective channel from the transmitters to the DU input is then:

$${H}_{k}^{D U} = {W}_{k} {H}_{k}$$

which is L×L. In many cases the effective channel is ill-conditioned, but, crucially, still invertible. This is especially true in scenarios where UEs are closely spaced in angle, (both in line of sight (LOS) and non-line of sight (NLOS). See an example of this in the section below. By ill-conditioned it means that the spread in power of the singular values is large. The choice of Wₖ affects how well- or ill-conditioned the effective channel becomes; in the examples the whitening matched filter (WMF):

$${W}_{k} = {H}_{k}^{*} {Q}^{- 1} ,$$

with Q being the covariance matrix of nₖ is used.

If the effective channel was known in the DU without estimation error, the equalization may be done without issue, however, as shown by evaluation results below, if the effective channel needs to be estimated, as is the practical scenario, having an ill-conditioned effective channel may cause severe performance degradations due to the non-orthogonality between DMRS ports.

FIG. 1 shows performance as a function of signal to noise ratio (SNR) using:
no port reduction curves, which means full bandwidth on the LLS interface;
using port reductions-curves; and
dashed lines are with ideal estimation algorithms, and solid lines are with practical.

Practical estimation algorithms are the same in the DU for both examples.

Evidently, performance deteriorates drastically with practical algorithms and port reduction, but not so much without port reduction. With ideal algorithms, a port reduction does not degrade performance compared to the full bandwidth LLS case.

An object of embodiments herein is to provide a mechanism that improves communication in an efficient manner.

According to an aspect the object may be achieved by providing a method performed by a DU of a radio network node for handling communication in a communications network. The DU receives from a radio unit of the radio network node, a port reduction mapped signal. The DU applies a whitening filter to the received port reduction mapped signal to create another signal that is used in subsequent processing. The RU may apply a port reduction mapping to a received signal, and the DU may further apply the whitening filter to the received signal to create another signal that is used in subsequent processing.

It is furthermore provided herein a computer program product comprising instructions, which, when executed on at least one processor, cause the at least one processor to carry out the methods here, as performed by the DU of the radio network node. It is additionally provided herein a computer-readable storage medium, having stored thereon a computer program product comprising instructions which, when executed on at least one processor, cause the at least one processor to carry out the methods herein, as performed by the DU of the radio network node.

Furthermore, it is herein disclosed a DU of a radio network node for handling communication in a communications network. The DU is configured to receive from a radio unit of the radio network node, a port reduction mapped signal. The DU is configured to apply a whitening filter to the received port reduction mapped signal to create another signal that is used in subsequent processing.

The embodiments herein may comprise one or more of the following:
A port reduction linear mapping Wₖ is applied at the RU to the create the port reduction mapped signal which is an effective received signal, denoted rₖ at a DU of the radio network node. The signal may be transferred over the LLS interface to the DU.
An effective covariance matrix, Rₖ, of the effective received signal (the port reduction mapped signal) for subcarrier k may be estimated based on the received signal rᵢ (for a range of i, the range being larger than L). The covariance matrix may be determined incoherently (disregarding the actual transmitted signal) on separate or both DMRS and data symbols.
The whitening filter, K, may be computed (for example

$$K = {R}_{k}^{- 1 / 2} , )$$

such that:

$$K {R}_{k} {K}^{*} ∼ {I}_{L}$$

wherein I_{L} is identity matrix
The whitening filter may be applied on rₖ to create another signal that may be used in subsequent DU side processing, e.g. DMRS channel estimation and decoding.

The whitening filter and the Rₖ may be computed with a lower granularity, i.e., lower number of uniquely computed instances per unit of bandwidth, compared to channel estimation for demodulation in the DU.

An advantage of the proposed method is that, at high SNR, the whitening filter proposed herein will make the effective channel better conditioned, which may help DMRS channel estimation separate non-orthogonal DMRS ports. This will lead to an improved performance and thus, embodiments herein provide a mechanism that handles communication in an efficient manner.

### BRIEF DESCRIPTION OF THE DRAWINGS

Examples of embodiments herein are described in more detail with reference to the attached drawings in which:

FIG. 1 shows a graph according to prior art;

FIG. 2 shows a schematic overview depicting a communication network according to embodiments herein;

FIG. 3a shows a schematic flowchart depicting a method performed by a radio network node;

FIG. 3b shows a schematic flowchart depicting a method performed by a DU according to embodiments herein;

FIG. 4 shows a schematic overview depicting some embodiments herein;

FIG. 5 shows a schematic overview depicting some embodiments herein;

FIG. 6 shows a schematic overview depicting some embodiments herein;

FIG. 7 shows schematic overview depicting a DU according to embodiments herein;

FIG. 8 shows an example of a communication system QQ100 in accordance with some embodiments;

FIG. 9 shows a UE QQ200 in accordance with some embodiments;

FIG. 10 shows a network node QQ300 in accordance with some embodiments;

FIG. 11 is a block diagram of a host QQ400, which may be an embodiment of the host QQ116 of FIG. 8, in accordance with various aspects described herein;

FIG. 12 is a block diagram illustrating a virtualization environment QQ500 in which functions implemented by some embodiments may be virtualized; and

FIG. 13 shows a communication diagram of a host QQ602 communicating via a network node QQ604 with a UE QQ606 over a partially wireless connection in accordance with some embodiments.

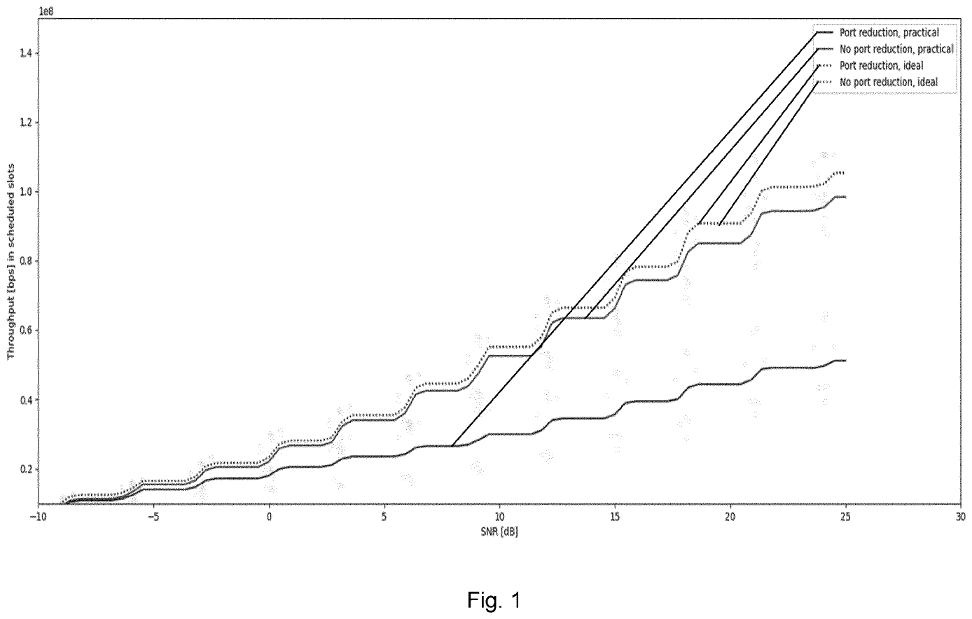

### DETAILED DESCRIPTION

Embodiments herein are described within the context of 3GPP NR radio technology. It is understood that the problems and solutions described herein are equally applicable to wireless access networks and UEs implementing other access technologies and standards. NR is used as an example technology where embodiments are suitable, and using NR in the description therefore is particularly useful for understanding the problem and solutions solving the problem. In particular, embodiments are applicable also to 6G, 3GPP LTE, or 3GPP LTE and NR integration, also denoted as non-standalone NR.

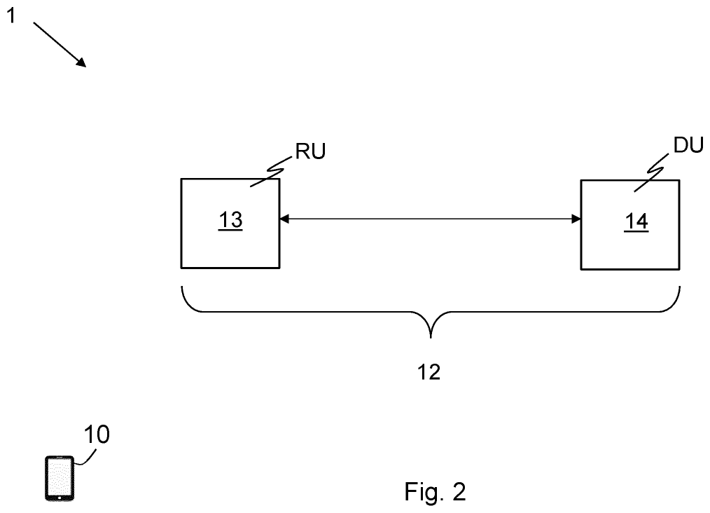

Embodiments herein relate to communication networks in general. FIG. 2 is a schematic overview depicting a communication network 1. The communication network 1 comprises one or more access networks, such as RANs, and one or more CNs. The communication network 1 may use one or a number of different technologies, such as Wi-Fi, LTE, LTE-Advanced, 5G, wired, WCDMA, Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. Embodiments herein relate to recent technology trends that are of particular interest in a 5G context, however, embodiments are also applicable in further development of the existing wireless communication systems such as e.g. WCDMA and LTE.

In the communication network 1, wireless devices e.g. a UE 10, such as a mobile station, a non-access point (non-AP) STA, a STA, a user equipment and/or a wireless terminal, communicate via one or more Access Networks (AN), e.g. RAN, to one or more CN. It should be understood by the skilled in the art that “UE” is a non-limiting term which means any terminal, wireless communication terminal, user equipment, Machine Type Communication (MTC) device, internet of things (IoT) capable device, Device to Device (D2D) terminal, or node e.g. smart phone, laptop, mobile phone, sensor, relay, mobile tablets or even a small base station capable of communicating using radio communication with a network node within an area served by the network node.

The communication network 1 comprises a radio network node 12 providing radio coverage over a geographical area, a first service area, of a radio access technology (RAT), such as NR, LTE, Wi-Fi, WiMAX or similar. The radio network node 12 may be a transmission and reception point e.g. a radio network node such as a Wireless Local Area Network (WLAN) access point or an Access Point Station (AP STA), an access node, an access controller, a base station, e.g. a radio base station such as a NodeB, an evolved Node B (eNB, eNode B), a gNodeB (gNB), a base transceiver station, a radio remote unit, an Access Point Base Station, a base station router, a transmission arrangement of a radio base station, a stand-alone access point or any other network unit or node capable of communicating with a UE within the area served by the radio network node 12 depending e.g. on the radio access technology and terminology used. The radio network node 12 may alternatively or additionally be a controller node or a packet processing node such as a radio controller node or similar. It should be noted that a service area may be denoted as cell, beam, beam group, or similar, to define an area of radio coverage.

The radio network node 12 may be referred to as a serving network node wherein the first service area may be referred to as a serving cell or primary cell, and the serving network node communicates with the UEs in form of DL transmissions to the UEs and UL transmissions from the UEs.

The radio network node 12 may be a distributed node comprising a RU 13 e.g., a RRU, a radio entity or similar, and a DU 14, such as a baseband unit, a processing unit or similar. The RU 13 may be connected to the DU 14 via an interface such as an LLS.

According to embodiments herein the RU 13 of the radio network node 12 applies a port reduction mapping to a received signal, and the DU 14 of the radio network node 12 further applies a whitening filter to the signal to create another (new) signal that is used in subsequent processing.

The received signals may, at the DU 14 or the RU 13, be used to determine the whitening filter (with no other side information conveyed over the interface) which is then applied to the signal prior to subsequent processing in the DU 14.

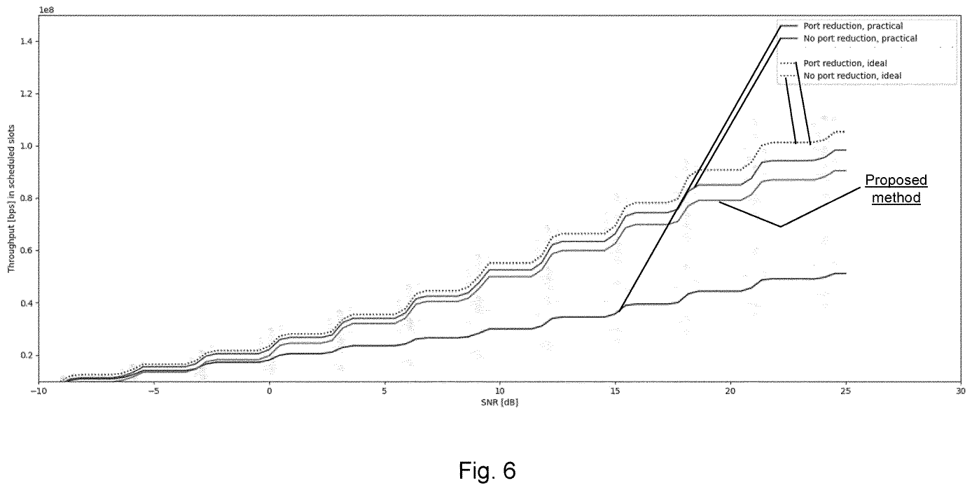

An advantage of the proposed method is that, for example, at high SNR, the whitening filter proposed herein will make the effective channel better conditioned, which will help DMRS channel estimation separate the non-orthogonal DMRS ports. This will improve demodulation performance, in some cases drastically, see results further in FIG. 6. The method does not require any side information such as channel estimates to be conveyed.

The embodiments herein work so well, compared to traditional DMRS channel estimation, because:
They may use the relatively large energy, large number of resource elements, transmitted on, for example, the data symbols, in addition to the DMRS, when determining the covariance matrix;
The embodiments may only assume that the data layers are statistically uncorrelated; and/or
The effective channel,

$${H}_{k}^{D U} ,$$

seen in the DU 14, is close to square and per definition full rank. Note that this is automatic when using a port reduction filter as in the O-RAN specification. In the general massive MIMO case with no port reduction this will not be the case.

An example of the performance improvement seen is given in the detailed description section below.

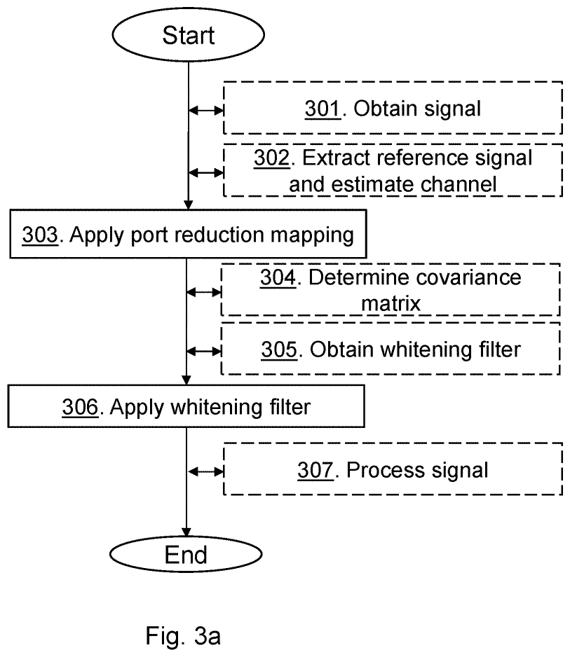

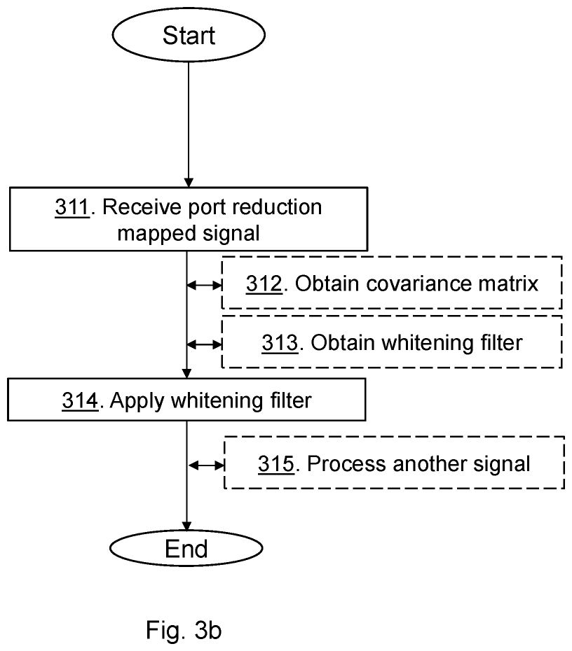

Example embodiments of a method performed by the radio network node 12 comprising the RU 13 and the DU 14 for handling communication in a communication network will now be described with reference to a flowchart depicted in FIG. 3a. The actions do not have to be taken in the order stated below, but may be taken in any suitable order. Dashed boxes are optional features.

Action 301. The RU 13 of the radio network node 12 may obtain such as receive one or more signals. For example, the RU 13 may receive a signal.

Action 302. The RU 13 of the radio network node 12 may extract reference signal and may estimate channel. For example, RU 13 may extract DMRS and estimate the radio channel Hₖ as seen from the RU 13.

Action 303. The RU 13 of the radio network node 12 applies a port reduction mapping to the signal. For example, the RU 13 may apply a port reduction linear mapping Wₖ. The RU port reduction may include computing and applying the linear port reduction transform Wₖ to the received signal. The signal may be transferred over the LLS interface.

Action 304. The DU 14 of the radio network node 12 may obtain a covariance matrix. The DU 14 or the RU 13 may estimate a covariance matrix, Rₖ, of the effective received signal for subcarrier k based on the received signal rᵢ (for a range of i, the range being larger than L). The covariance matrix may be determined incoherently on both DMRS and data symbols. The covariance matrix, Rₖ, may be computed in the RU 13, and forwarded to the DU 14, possibly with a relatively low frequency-domain resolution to keep the RU-DU interface bandwidth (BW) low. If the covariance matrix is computed in the RU 13, it may utilize information from the channel and/or estimate in the RU 13 to further improve accuracy.

Action 305. The DU 14 of the radio network node 12 may obtain the whitening filter. The DU 14 or the RU 13 may compute the whitening filter using Schur decomposition, eigenvalue and/or single value decomposition (SVD), Jordan decomposition. For example, the DU 14 may compute the whitening filter, K, (for example

$$K = {R}_{k}^{- 1 / 2} , )$$

such that:

$$K {R}_{k} {K}^{*} ∼ {I}_{L}$$

wherein I_{L} is identity matrix.

Action 306. The DU 14 of the radio network node 12 applies the whitening filter to the signal to create another (new) signal that is used in subsequent DU side processing. For example, the DU 14 may apply the whitening filter (based on the covariance matrix) to the signal prior to subsequent processing in the DU 14.

Action 307. The radio network node 12 may process the created other signal. For example, the DU 14 may use the other signal for DMRS channel estimation and/or decoding

Example embodiments of a method performed by the DU 14 of the radio network node 12 for handling communication in the communication network will now be described with reference to a flowchart depicted in FIG. 3b. The actions do not have to be taken in the order stated below, but may be taken in any suitable order. Dashed boxes are optional features.

Action 311. The DU 14 receives from the RU 13 of the radio network node 12, a port reduction mapped signal.

Action 312. The DU 14 may obtain a covariance matrix. The DU 14 may estimate a covariance matrix, Rₖ, of the received port reduction mapped signal for subcarrier k based on the received port reduction mapped signal rᵢ, e.g., for a range of i, the range being larger than L, and/or data symbols of the received port reduction mapped signal. The covariance matrix may be determined incoherently on both DMRS and data symbols. The DU 14 may use at least data symbols for the covariance estimation, i.e. not just DMRS. The covariance matrix, Rₖ, may be computed in the RU 13, and forwarded to the DU 14, possibly with a relatively low frequency-domain resolution to keep the RU-DU interface BW low. If the covariance is computed in the RU 13, it may utilize information from the channel and/or estimate in the RU 13 to further improve accuracy.

Action 313. The DU 14 may obtain the whitening filter. The DU 14 or the RU 13 may compute the whitening filter using Schur decomposition, eigenvalue, SVD, or a Jordan decomposition. For example, the DU 14 may compute the whitening filter, K, (for example

$$K = {R}_{k}^{- 1 / 2} , )$$

such that:

$$K {R}_{k} {K}^{*} ∼ {I}_{L}$$

The whitening filter may be computed with a lower number of uniquely computed instances per unit of bandwidth compared to channel estimation for demodulation in the DU 14. The whitening filter may be computed with a lower granularity, i.e. do averaging over multiple subcarriers and/or physical resource blocks (PRB) compared to channel estimation for demodulation in the DU 14.

Action 314. The DU 14 applies the whitening filter to the received port reduction mapped signal to create another signal that is used in subsequent processing. For example, the DU 14 may apply the whitening filter (based on the covariance matrix) to the signal prior to subsequent processing in the DU 14. The DU 14 may apply the whitening filter based on the obtained covariance matrix. The subsequent processing may be performed in the DU 14, and the whitening filter may be applied to the received port reduction mapped signal prior to subsequent processing in the DU 14.

Action 315. The DU 14 may process the created other signal for estimating a channel. For example, the DU 14 may use the created other signal for DMRS channel estimation and/or decoding.

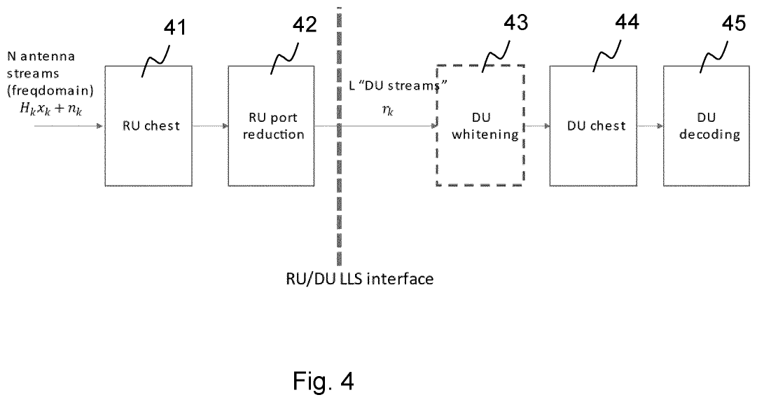

FIG. 4 is a flowchart that describes one or more functional blocks relevant to understanding embodiments herein:
The thick dashed line represents the RU and/or DU split, which could be the LLS of O-RAN, it conveys L port reduced antenna streams.
RU chest 41 may include extracting DMRS and estimating the radio channel Hₖ as seen from RU.
RU port reduction 42 may include computing and applying the linear port reduction transform Wₖ
DU whitening 43 (the dashed box) computes and applies the whitening filter according to embodiments herein.

During DU whitening 43, a filter is being applied to the output streams from the RU 13 such that to alleviate a potential ill-conditioned effective channel from DU perspective which sets difficulties in DU decoding and may consequently degrade the performance”

After applying the DU whitening 43, the received streams are used in DU chest 44 in order to estimate the channel coefficients during the transmission time which are used as input in DU decoder 45 (along with the noise estimate) in order to decode the received signal and extract the transmitted bits.

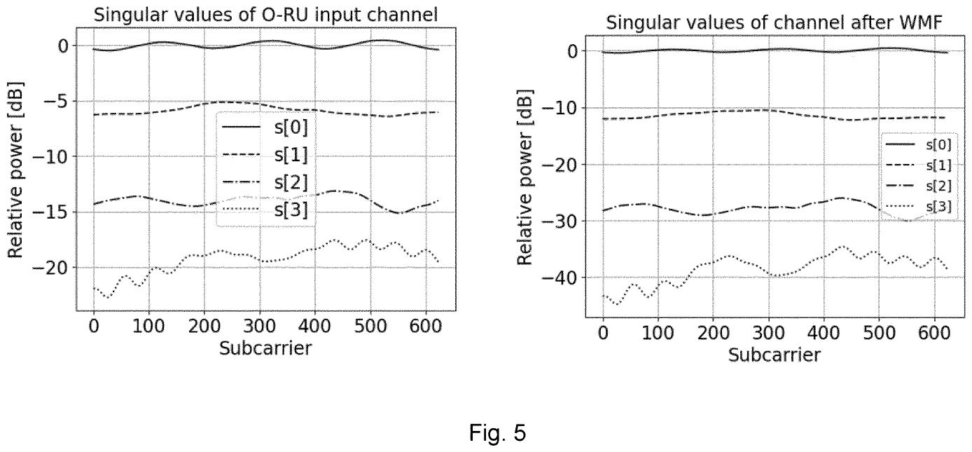

FIG. 5 is an example of singular values, per subcarrier on x-axis, of the channel as seen by the RU 13, Hₖ, (left) and the effective channel at the DU 14, WₖHₖ (right). Note the very large spread in the channel at the DU 14.

Example of the performance improvement of embodiments herein:

FIG. 6 is the diagram in the Summary but with another line added, that represent performance of the proposed method. Clearly, with the proposed solution the performance improves dramatically, thus, the added line is closer to the line of not using a port reduction.

According to some embodiments herein:

A port reduction linear mapping Wₖ is applied by the RU 13.

In some embodiments this is represented by a matrix mapping N antenna streams down to L layers, L being equal to the number of data layers.

The DU 14 or the RU 13 may estimate the effective covariance matrix Rₖ.

In one embodiment this comprises computing the outer product of the effective received signal:

$${( {r}_{i} {r}_{i}^{*} )}^{*}$$

(any Hermitian matrix with dimension L×L can be represented by L\hat{ }2 real scalars)

In one embodiment, the effective covariance matrix Rₖ may be computed as

$${R}_{k} = {\sum }_{i ∈ {S}_{k}} {{w}_{k , i} ( {r}_{i} {r}_{i}^{*} )}^{*}$$

where Sₖ is the set of resource element indices close to the resource element k, and w_{k,i} is scalar weights.

In some embodiments, the set of resource element indices Sₖ and w_{k,i} may be determined by a measure of channel fading:
e.g., with a frequency selective channel wᵢ might create less smoothing over frequency;
e.g., with a fast time varying channel less smoothing over time is required.

In some embodiments, the w_{k,i} represent a Wiener filter in the frequency domain. In some embodiments, the wᵢ represent a sliding window in the frequency domain; the sliding window can be rectangular, or have some other shape.

In some embodiments, only data symbols are used to compute the covariance matrix.

In some embodiments, DMRS and data symbols are used to compute the covariance matrix.

In some embodiments, DMRS with an optional linear preprocessing step are used to compute the covariance matrix.

A whitening filter,

$$K = {R}_{k}^{- 1 / 2} ,$$

may be computed.

This may be computed using Schur decomposition, eigenvalue and/or SVD, Jordan decomposition.

In some embodiments, K is not an exact square-root matrix, but instead approximate (for example by regularizing).

In some embodiments, the number of streams in the interface between the RU 13 and the DU 14 is different from the number of users and/or transmit layers, i.e.

$${H}_{k}^{D U} = {W}_{k} {H}_{k}$$

is not an L×L matrix, but rather an L′×L″ matrix, where L′ is the number of streams in the RU-DU interface and L″ is the number of users and/or transmit layers, and L′≠L″.

In some embodiments, all or parts of the computations in the whitening filter may be performed within the RU 13. If all parts are performed in the RU 13, it may be better labelled as a RU whitening instead of a DU whitening. For example, the effective covariance Rₖ may be computed in the RU 13, and forwarded to the DU 14, possibly with a relatively low frequency-domain resolution to keep the RU-DU interface BW low. If the covariance matrix is computed in the RU 13, it may utilize information from the channel and/or estimate in the RU 13 to further improve accuracy.

In some embodiments, the whitening filter Wₖ is not explicitly calculated, but the computations performed are mathematically equivalent, for example, within numerical precision, and apart from any regularizations to handle e.g. numerical precision and/or stability issues.

In some embodiments, the whitening filter is only partial, i.e. the whitening filter, or the mathematically equivalent computations within numerical precision, does not aim to make the resulting effective covariance perfectly diagonal, but still to make it more well-conditioned, e.g. less spread of singular values, and/or more diagonal-heavy.

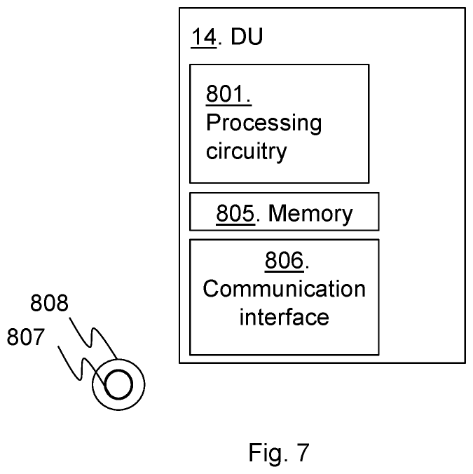

FIG. 7 is a block diagram depicting the DU 14, according to embodiments herein for handling communication in the communication network 1.

The DU 14may comprise a respective processing circuitry 801, e.g., one or more processors, configured to perform the methods herein, respectively.

The DU 14 of the radio network node 12 and/or the processing circuitry 801 is configured to receive from the RU 13 of the radio network node 12, the port reduction mapped signal.

The DU 14 of the radio network node 12 and/or the processing circuitry 801 may be configured to obtain the covariance matrix. The covariance matrix may be computed in the RU 13, and the DU 14 may be configured to receive the covariance matrix from the RU 13.

The DU 14 of the radio network node 12 and/or the processing circuitry 801 may be configured to obtain the whitening filter. The DU 14 and/or the processing circuitry 801 may be configured to compute the whitening filter using Schur decomposition, eigenvalue, SVD, or Jordan decomposition. The whitening filter may be computed with a lower number of uniquely computed instances per unit of bandwidth compared to channel estimation for demodulation in the DU 14.

The DU 14 of the radio network node 12 and/or the processing circuitry 801 is configured to apply the whitening filter to the received port reduction mapped signal to create another signal that is used in subsequent processing. The DU 14 and/or the processing circuitry 801 may be configured to apply the whitening filter (based on the covariance matrix) to the signal prior to subsequent processing in the DU 14. Thus, the DU 14 and/or the processing circuitry 801 may be configured to perform the subsequent processing, and may be configured to apply the whitening filter to the received port reduction mapped signal prior to subsequent processing in the DU 14.

The DU 14 of the radio network node 12 and/or the processing circuitry 801 may be configured to obtain the covariance matrix of the received port reduction mapped signal for subcarrier k based on the received port reduction mapped signal and/or data symbols of the received port reduction mapped signal; and to apply the whitening filter is based on the obtained covariance matrix.

It should be noted that the RU 13 may be configured to obtain, such as receive, one or more signals. The RU 13 may be configured to extract reference signal and may estimate channel. The RU 13 may be configured to apply the port reduction mapping to the signal. For example, the RU 13 may be configured to apply a port reduction linear mapping Wₖ. The RU port reduction may include computing and applying the linear port reduction transform Wₖ. The signal may be transferred over the LLS interface.

The DU 14 of the radio network node 12 and/or the processing circuitry 801 may be configured to process the created other signal for estimating a channel. The DU 14 may comprise a memory 805. The memory comprises one or more units to be used to store data on, such as data packets, signals, whitening filter, covariance matrices, estimations, channels, processing time, configurations, measured parameters, data storage, data structures, hash table, indications, events and applications to perform the methods disclosed herein when being executed, and similar. Furthermore, the DU 14 may comprise a communication interface 806 such as comprising a transmitter, a receiver, a transceiver and/or one or more antennas.

The methods according to the embodiments described herein for the DU 14 are respectively implemented by means of e.g., a computer program product 807 or a computer program, comprising instructions, i.e., software code portions, which, when executed on at least one processor, cause the at least one processor to carry out the actions described herein, as performed by the DU 14. The computer program product 807 may be stored on a computer-readable storage medium 808, e.g., a disc, a universal serial bus (USB) stick or similar. The computer-readable storage medium 808 having stored thereon the computer program product, may comprise the instructions which, when executed on at least one processor, cause the at least one processor to carry out the actions described herein, as performed by the DU 14. In some embodiments, the computer-readable storage medium may be a transitory or a non-transitory computer-readable storage medium. Thus, embodiments herein may disclose a DU 14 for handling communication in a communication network, wherein the DU 14 comprises processing circuitry and a memory, said memory comprising instructions executable by said processing circuitry whereby said DU 14 is operative to perform any of the methods herein.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications devices will appreciate the cost, performance, and maintenance trade-offs inherent in these design choices.

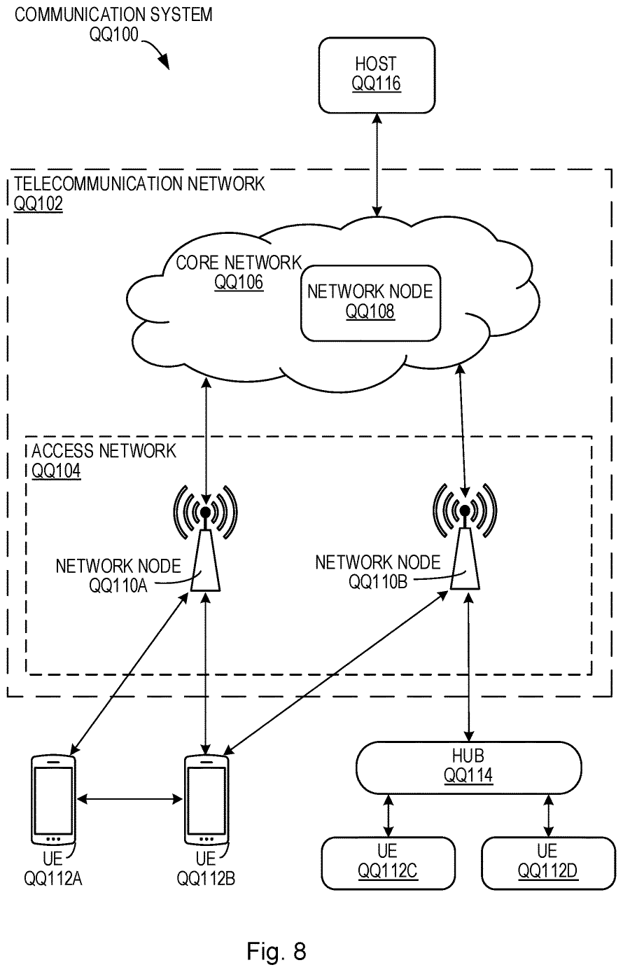

FIG. 8 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110 or radio network node 12), or any other similar 3^{rd} Generation Partnership Project (3GPP) access nodes or non-3GPP access points. Moreover, as will be appreciated by those of skill in the art, a network node, being examples of the entities herein, is not necessarily limited to an implementation in which a radio portion and a baseband portion are supplied and integrated by a single vendor. Thus, it will be understood that network nodes include disaggregated implementations or portions thereof. For example, in some embodiments, the telecommunication network QQ102 includes one or more Open-RAN (ORAN) network nodes. An ORAN network node is a node in the telecommunication network QQ102 that supports an ORAN specification (e.g., a specification published by the O-RAN Alliance, or any similar organization) and may operate alone or together with other nodes to implement one or more functionalities of any node in the telecommunication network QQ102, including one or more network nodes QQ110 and/or core network nodes QQ108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more hosts, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102, and may be operated by the service provider or on behalf of the service provider. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR headset, display, loudspeaker or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

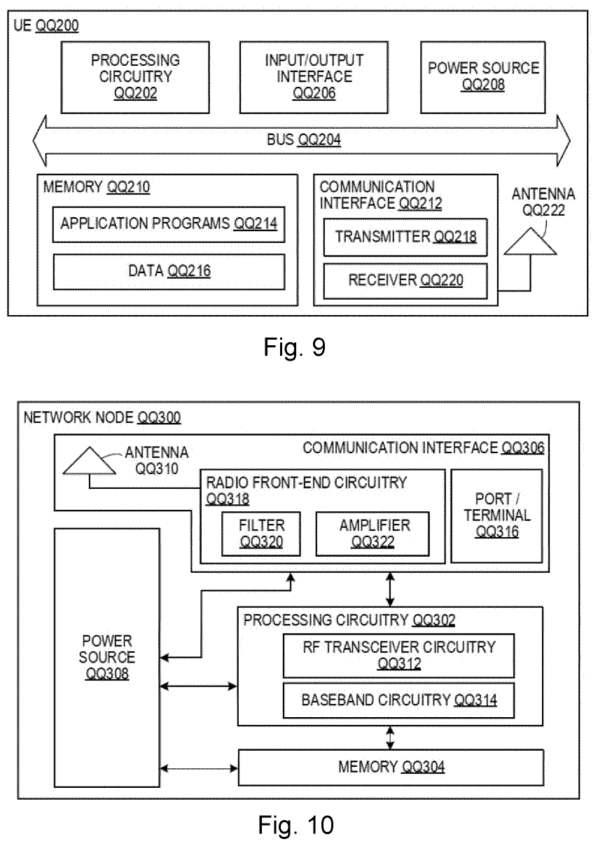

FIG. 9 shows a UE QQ200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node QQ300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signalling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 10 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300.

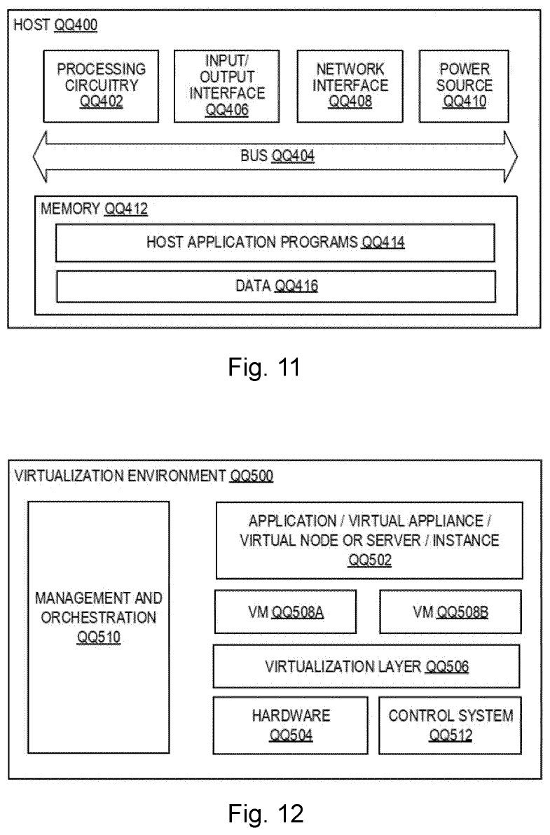

FIG. 11 is a block diagram of a host QQ400, which may be an embodiment of the host QQ116 of FIG. 8, in accordance with various aspects described herein. As used herein, the host QQ400 may be or comprise various combinations hardware and/or software, including a standalone server, a blade server, a cloud-implemented server, a distributed server, a virtual machine, container, or processing resources in a server farm. The host QQ400 may provide one or more services to one or more UEs.

The host QQ400 includes processing circuitry QQ402 that is operatively coupled via a bus QQ404 to an input/output interface QQ406, a network interface QQ408, a power source QQ410, and a memory QQ412. Other components may be included in other embodiments. Features of these components may be substantially similar to those described with respect to the devices of previous figures, such as FIGS. 9 and 10, such that the descriptions thereof are generally applicable to the corresponding components of host QQ400.

The memory QQ412 may include one or more computer programs including one or more host application programs QQ414 and data QQ416, which may include user data, e.g., data generated by a UE for the host QQ400 or data generated by the host QQ400 for a UE. Embodiments of the host QQ400 may utilize only a subset or all of the components shown. The host application programs QQ414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs QQ414 may also provide for user authentication and licensing checks and may periodically report health, routes, and content availability to a central node, such as a device in or on the edge of a core network. Accordingly, the host QQ400 may select and/or indicate a different host for over-the-top services for a UE. The host application programs QQ414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 12 is a block diagram illustrating a virtualization environment QQ500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment QQ500 includes components defined by the O-RAN Alliance, such as an O-Cloud environment orchestrated by a Service Management and Orchestration Framework via an O-2 interface.

Applications QQ502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ506 (also referred to as hypervisors or virtual machine monitors (VMMs)), provide VMs QQ508a and QQ508b (one or more of which may be generally referred to as VMs QQ508), and/or perform any of the functions, features and/or benefits described in relation with some embodiments described herein. The virtualization layer QQ506 may present a virtual operating platform that appears like networking hardware to the VMs QQ508.

The VMs QQ508 comprise virtual processing, virtual memory, virtual networking or interface and virtual storage, and may be run by a corresponding virtualization layer QQ506. Different embodiments of the instance of a virtual appliance QQ502 may be implemented on one or more of VMs QQ508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ508 may be a software implementation of a physical machine that runs programs as if they were executing on a physical, non-virtualized machine. Each of the VMs QQ508, and that part of hardware QQ504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ508 on top of the hardware QQ504 and corresponds to the application QQ502.

Hardware QQ504 may be implemented in a standalone network node with generic or specific components. Hardware QQ504 may implement some functions via virtualization. Alternatively, hardware QQ504 may be part of a larger cluster of hardware (e.g. such as in a data center or CPE) where many hardware nodes work together and are managed via management and orchestration QQ510, which, among others, oversees lifecycle management of applications QQ502. In some embodiments, hardware QQ504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signalling can be provided with the use of a control system QQ512 which may alternatively be used for communication between hardware nodes and radio units.

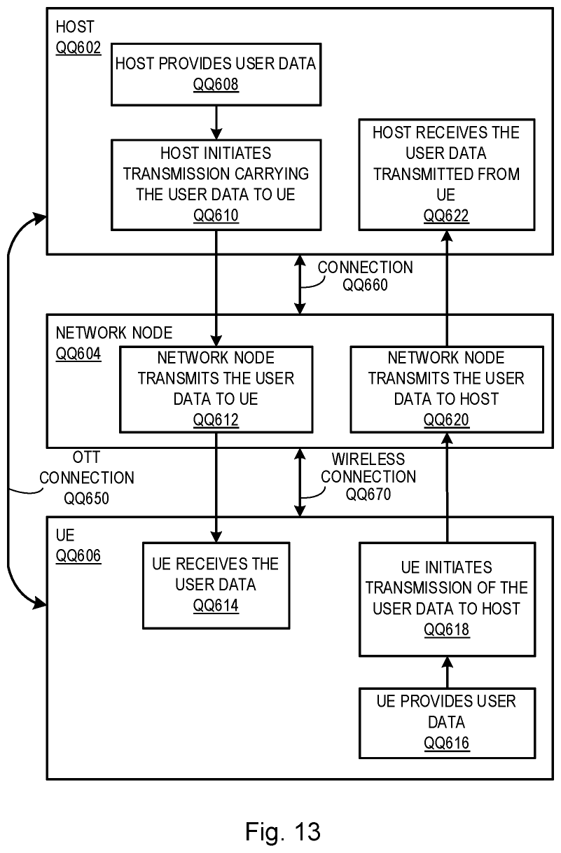

FIG. 13 shows a communication diagram of a host QQ602 communicating via a network node QQ604 with a UE QQ606 over a partially wireless connection in accordance with some embodiments. Example implementations, in accordance with various embodiments, of the UE (such as a UE QQ112a of FIG. 8 and/or UE QQ200 of FIG. 9), network node (such as network node QQ110a of FIG. 8 and/or network node QQ300 of FIG. 10), and host (such as host QQ116 of FIG. 8 and/or host QQ400 of FIG. 11) discussed in the preceding paragraphs will now be described with reference to FIG. 13.

Like host QQ400, embodiments of host QQ602 include hardware, such as a communication interface, processing circuitry, and memory. The host QQ602 also includes software, which is stored in or accessible by the host QQ602 and executable by the processing circuitry. The software includes a host application that may be operable to provide a service to a remote user, such as the UE QQ606 connecting via an over-the-top (OTT) connection QQ650 extending between the UE QQ606 and host QQ602. In providing the service to the remote user, a host application may provide user data which is transmitted using the OTT connection QQ650.

The network node QQ604 includes hardware enabling it to communicate with the host QQ602 and UE QQ606. The connection QQ660 may be direct or pass through a core network (like core network QQ106 of FIG. 8) and/or one or more other intermediate networks, such as one or more public, private, or hosted networks. For example, an intermediate network may be a backbone network or the Internet.

The UE QQ606 includes hardware and software, which is stored in or accessible by UE QQ606 and executable by the UE's processing circuitry. The software includes a client application, such as a web browser or operator-specific “app” that may be operable to provide a service to a human or non-human user via UE QQ606 with the support of the host QQ602. In the host QQ602, an executing host application may communicate with the executing client application via the OTT connection QQ650 terminating at the UE QQ606 and host QQ602. In providing the service to the user, the UE's client application may receive request data from the host's host application and provide user data in response to the request data. The OTT connection QQ650 may transfer both the request data and the user data. The UE's client application may interact with the user to generate the user data that it provides to the host application through the OTT connection QQ650.

The OTT connection QQ650 may extend via a connection QQ660 between the host QQ602 and the network node QQ604 and via a wireless connection QQ670 between the network node QQ604 and the UE QQ606 to provide the connection between the host QQ602 and the UE QQ606. The connection QQ660 and wireless connection QQ670, over which the OTT connection QQ650 may be provided, have been drawn abstractly to illustrate the communication between the host QQ602 and the UE QQ606 via the network node QQ604, without explicit reference to any intermediary devices and the precise routing of messages via these devices.

As an example of transmitting data via the OTT connection QQ650, in step QQ608, the host QQ602 provides user data, which may be performed by executing a host application. In some embodiments, the user data is associated with a particular human user interacting with the UE QQ606. In other embodiments, the user data is associated with a UE QQ606 that shares data with the host QQ602 without explicit human interaction. In step QQ610, the host QQ602 initiates a transmission carrying the user data towards the UE QQ606. The host QQ602 may initiate the transmission responsive to a request transmitted by the UE QQ606. The request may be caused by human interaction with the UE QQ606 or by operation of the client application executing on the UE QQ606. The transmission may pass via the network node QQ604, in accordance with the teachings of the embodiments described throughout this disclosure. Accordingly, in step QQ612, the network node QQ604 transmits to the UE QQ606 the user data that was carried in the transmission that the host QQ602 initiated, in accordance with the teachings of the embodiments described throughout this disclosure. In step QQ614, the UE QQ606 receives the user data carried in the transmission, which may be performed by a client application executed on the UE QQ606 associated with the host application executed by the host QQ602.

In some examples, the UE QQ606 executes a client application which provides user data to the host QQ602. The user data may be provided in reaction or response to the data received from the host QQ602. Accordingly, in step QQ616, the UE QQ606 may provide user data, which may be performed by executing the client application. In providing the user data, the client application may further consider user input received from the user via an input/output interface of the UE QQ606. Regardless of the specific manner in which the user data was provided, the UE QQ606 initiates, in step QQ618, transmission of the user data towards the host QQ602 via the network node QQ604. In step QQ620, in accordance with the teachings of the embodiments described throughout this disclosure, the network node QQ604 receives user data from the UE QQ606 and initiates transmission of the received user data towards the host QQ602. In step QQ622, the host QQ602 receives the user data carried in the transmission initiated by the UE QQ606.

One or more of the various embodiments improve the performance of OTT services provided to the UE QQ606 using the OTT connection QQ650, in which the wireless connection QQ670 forms the last segment. More precisely, the teachings of these embodiments may improve the channel estimation and thereby provide benefits such as reduced user waiting time, better energy savings, better responsiveness or similar.

In an example scenario, factory status information may be collected and analyzed by the host QQ602. As another example, the host QQ602 may process audio and video data which may have been retrieved from a UE for use in creating maps. As another example, the host QQ602 may collect and analyze real-time data to assist in controlling vehicle congestion (e.g., controlling traffic lights). As another example, the host QQ602 may store surveillance video uploaded by a UE. As another example, the host QQ602 may store or control access to media content such as video, audio, VR or AR which it can broadcast, multicast or unicast to UEs. As other examples, the host QQ602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection QQ650 between the host QQ602 and UE QQ606, in response to variations in the measurement results. The measurement procedure and/or the network functionality for reconfiguring the OTT connection may be implemented in software and hardware of the host QQ602 and/or UE QQ606. In some embodiments, sensors (not shown) may be deployed in or in association with other devices through which the OTT connection QQ650 passes; the sensors may participate in the measurement procedure by supplying values of the monitored quantities exemplified above, or supplying values of other physical quantities from which software may compute or estimate the monitored quantities. The reconfiguring of the OTT connection QQ650 may include message format, retransmission settings, preferred routing etc.; the reconfiguring need not directly alter the operation of the network node QQ604. Such procedures and functionalities may be known and practiced in the art. In certain embodiments, measurements may involve proprietary UE signalling that facilitates measurements of throughput, propagation times, latency and the like, by the host QQ602. The measurements may be implemented in that software causes messages to be transmitted, in particular empty or ‘dummy’ messages, using the OTT connection QQ650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

| Abbreviation | Explanation |
|---|---|
| DMRS | Demodulation reference signals |
| DL | Downlink |
| DU | Distributed unit |
| LLS | Lower layer split |
| MIMO | Multiple-input multiple-output |
| MU-MIMO | Multi-user MIMO |
| OCC | Orthogonal cover code |
| O-RAN | Open RAN |
| RE | Radio equipment |
| REC | Radio equipment controller |
| RU | Radio unit |
| SNR | Signal-to-noise ratio |
| UL | Uplink |
| WMF | Whitening matched filter |

### REFERENCES

1. O-RAN WG4 specifications, https://www.o-ran.org/specifications
2. 3GPP TR 38.816 V15.0.0, “Study on CU-DU lower layer split for NR”

1-16. (canceled)

17. A method performed by a distributed unit (DU) of a radio network node for handling communication in a communications network, the method comprising:
receiving from a radio unit (RU) of the radio network node, a port reduction mapped signal; and
applying a whitening filter to the received port reduction mapped signal to create another signal that is used in subsequent processing.

18. The method according to claim 17, further comprising obtaining a covariance matrix of the received port reduction mapped signal for subcarrier k based on the received port reduction mapped signal and/or data symbols of the received port reduction mapped signal, and wherein application of the whitening filter is based on the obtained covariance matrix.

19. The method according to claim 18, wherein the covariance matrix is computed in the RU and forwarded to the DU.

20. The method according to claim 17, wherein the subsequent processing is performed in the DU, and the whitening filter is applied to the received port reduction mapped signal prior to the subsequent processing.

21. The method according to claim 17, further comprising obtaining the whitening filter using a Schur decomposition, eigenvalue, single value decomposition, or a Jordan decomposition.

22. The method according to claim 17, further comprising processing the created other signal for estimating a channel.

23. The method according to claim 17, wherein the whitening filter is computed with a lower number of uniquely computed instances per unit of bandwidth compared to channel estimation for demodulation in the DU.

24. A distributed unit (DU) of a radio network node for handling communication in a communications network, wherein the DU comprises:
a communication interface; and
processing circuitry configured to:
receive a port reduction mapped signal from a radio unit (RU) of the radio network node, the port reduction mapped signal received via the communication interface; and
apply a whitening filter to the received port reduction mapped signal to create another signal that is used in subsequent processing.

25. The DU according to claim 24, wherein the processing circuitry is configured to obtain a covariance matrix of the received port reduction mapped signal for subcarrier k based on the received port reduction mapped signal and/or data symbols of the received port reduction mapped signal, and wherein application of the whitening filter is based on the obtained covariance matrix.

26. The DU according to claim 25, wherein the covariance matrix is computed in the RU, and the processing circuitry is configured to receive the covariance matrix from the RU, via the communication interface.

27. The DU according to claim 24, wherein the processing circuitry is configured to perform the subsequent processing and configured to apply the whitening filter to the received port reduction mapped signal prior to the subsequent processing.

28. The DU according to claim 24, wherein the processing circuitry is configured to obtain the whitening filter using a Schur decomposition, eigenvalue, single value decomposition, or a Jordan decomposition.

29. The DU according to claim 24, wherein the processing circuitry is configured to process the created other signal for estimating a channel.

30. The DU according to claim 24, wherein the whitening filter is computed with a lower number of uniquely computed instances per unit of bandwidth compared to channel estimation for demodulation in the DU.
